(19) United States
(12) Patent Application Publication
(10) Pub. No.: US 2018/0211215 A1
(43) Pub. Date: Jul. 26, 2018

(54) SYSTEM FOR MONITORING THE TRANSPORT CONDITIONS OF GOODS

(71) Applicant: S4GV SA, Montagny-Yverdon (CH)

(72) Inventor: Pierre Ruggiero, Bogis-Bossey (CH)

(21) Appl. No.: 15/745,025

(22) PCT Filed: Jul. 14, 2016
(86) PCT No.: PCT/IB2016/054202

§ 371 Date: Jan. 15, 2018

(30) Foreign Application Priority Data
Jul. 17, 2015 (EP) 15177298.5

(51) Int. Cl. G06Q 10/08; B65D 79/02; B65D 55/02; G08B 25/10

(52) U.S. Cl. CPC G06Q 10/0833; G08B 25/10; B65D 55/02; B65D 79/02

(57) ABSTRACT

The invention relates to a system and method for monitoring the transport conditions of goods. The system comprises a central server (2) which communicates with at least one communicating lock (3) interacting with at least one measurement sensor (4) directly affixed on the transported goods. The system minimises theft of goods by being able to rapidly detect intrusion attempts within transport containers.

### TECHNICAL FIELD OF THE INVENTION

The invention relates to the fields of computerized systems for monitoring goods during transport. The invention in particular pertains to a system for monitoring goods comprising a central server. The invention further relates to a method for monitoring goods implemented using such a system.

### BACKGROUND OF THE INVENTION

Many different types of computerized systems facilitating the monitoring of goods during transport are used at this time. Such systems are generally based on a central server that communicates with reading devices distributed along a transport chain and using which identification information affixed on the goods, generally in the form of barcodes or QR codes, is periodically scanned. Such systems are generally limited to locating the goods in different locations in order to determine the path followed by the goods along the transport chain.

However, although these systems make it possible to obtain partial information on the location of goods in different locations of the transport chain, they do not allow a precise determination of the stresses to which the goods are subjected during transport. In other words, these systems do not make it possible to determine the conditions under which the goods are transported with certainty. This drawback may be particularly problematic when the transported goods are perishable foodstuffs, but also when it proves necessary, for legal reasons for instance, to be able to determine the exact conditions under which the goods were transported, and not just in various places along the transport journey, but rather throughout the entire journey.

Additionally, the current systems for monitoring goods do not make it possible to secure the goods effectively all throughout transport, in particular against theft. Indeed, when the goods are for example transported by sea, land or air, the securing techniques are generally based on seals that are affixed on the transport containers. Yet the use of these seals for securing purposes, in particular to detect any intrusion attempts in the transport containers, are generally limited to a visual analysis conducted by an authorized staff member who inspects the integrity of the seals at various locations of the transport chain. This approach means that the current systems for tracking goods, which are based on the use of such securing means, do not effectively secure goods throughout the entire transport journey, and in particular, do not allow quick detection of attempted intrusions seeking to access the goods transported in transport containers.

### BRIEF DESCRIPTION OF THE INVENTION

One aim of the invention is to offset these drawbacks, more specifically to provide a system for monitoring goods that makes it possible to establish the exact transport conditions during the transport of the goods.

Another aim of the invention is to provide a system for monitoring goods that makes it possible to determine the transport conditions not only at various points of the transport journey, but also throughout the entire journey thereof.

Another aim of the invention is to provide a system for monitoring goods that improves securing of the goods against theft, in particular when the goods are transported in containers by sea, land or air.

Another aim of the invention is to provide a system for monitoring goods which, in the context of goods transported in containers by sea or air, improves the speed with which openings of the transport containers are detected.

Another aim of the invention is to provide a system for monitoring goods that makes it possible to vary the observation parameters of the transport conditions.

These aims are achieved by a system for monitoring goods comprising at least one server, the system comprising at least one communicating lock and at least one measuring sensor, the communicating lock comprising inspection means and first communication means, the first communication means being configured to send and receive radiofrequency signals, the measuring sensor comprising a processor, measuring means for measuring at least one physical parameter, a memory and second communication means, the memory being able, upon instructions from the processor, to lastingly store at least one value of a physical parameter measured using the measuring means, the second communication means being configured to send radiofrequency signals, the inspection means and/or the processor being configured to determine whether a value of a physical parameter measured using the measuring means (m) is compliant with a setpoint parameter.

The term “communicating lock” refers to a locking system able to comprise, in addition to the electronic elements and means described below, mechanical locking elements such as a pin, cable, guide pin or the like. In one particular operating mode, the communicating lock preferably does not contain any mechanical locking element.

According to one feature, the communicating lock may comprise a first and second jack for connecting the two ends of an optical fiber, the inspection means being able, when the first end of the fiber is connected to the first jack and the second end of the fiber is connected to the second jack, to determine the integrity of an optical fiber and the connected or disconnected status of the first and second jacks.

According to one feature, the second communication means can be configured to receive radiofrequency signals.

According to another feature, the measuring means can comprise means for measuring the ambient temperature.

According to another feature, the measuring means can comprise means for measuring the ambient humidity.

According to another feature, the measuring means can comprise means for measuring the light intensity.

According to another feature, the measuring means can comprise means for measuring the pressure.

According to another feature, the measuring means can comprise means for detecting the presence of a gas.

According to another feature, the communicating lock may comprise a geolocation module.

According to another feature, the communicating lock may comprise a movement detection module.

According to another feature, the communicating lock may comprise power supply means confined in a box made from a material limiting the propagation risks of a fire resulting from a failure of the power supply means to the entire communicating lock.

According to another feature, the material may be aluminum or a mixture of polycarbonate and acrylonitrile butadiene styrene.

Another aspect of the invention relates to a method for monitoring goods implemented by a system for monitoring goods as described above, the method comprising the following steps:
reception by the server of the first piece of location information sent by the communicating lock;
sending by the server of a work instruction intended for the communicating lock, the work instruction indicating a measurement frequency;
sending by the communicating lock of the work instruction to the measuring sensor; and
modification by the processor of the measuring sensor of the frequency of the measurements done using the measuring means of the measuring sensor based on the work indication.

According to one feature, the method may comprise the following steps:
reception by the server of a second piece of location information sent by the communicating lock;
sending by the server of a stop instruction intended for the communicating lock;
sending by the communicating lock of the stop instruction intended for the measuring sensor; and
extinguishing of the measuring means of the measuring sensor.

### BRIEF DESCRIPTION OF THE FIGURES

Other features and advantages of the invention will emerge from reading the following description, done in reference to the appended figures, which illustrate:

FIG. 1, a schematic view of the system for monitoring goods according to the invention;

FIG. 2, a schematic view of a communicating lock of the system for monitoring goods according to the invention;

FIG. 3, a schematic view of a measuring sensor of the system for monitoring goods according to the invention; and

FIG. 4, a schematic view of a monitoring method according to the invention.

### DETAILED DESCRIPTION OF THE INVENTION

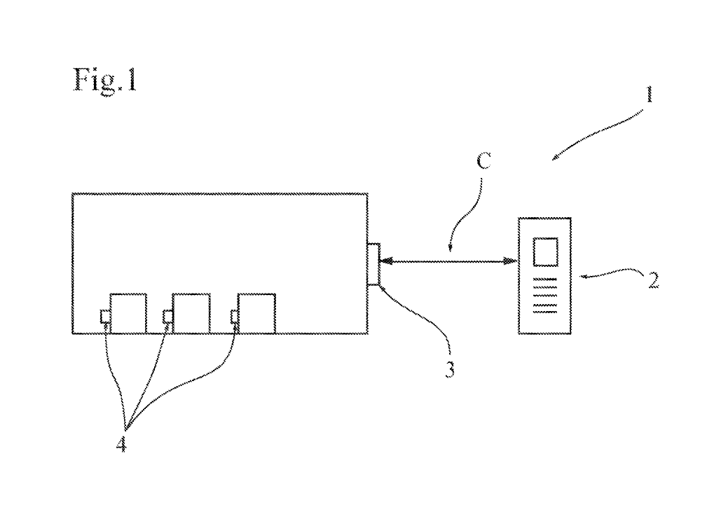

FIG. 1 schematically shows a system for monitoring goods 1 according to the invention. The system comprises a server 2 with which at least one communicating lock 3 communicates via a communication channel “C”. In light of the communication means with which the communicating lock 3 is provided, which will be described in detail below, the communication channel “C” may include a network for transferring data, such as the Internet, a mobile communication network or a communication network including one or several communication satellites. Thus, the server 2 and the communicating lock 3 are able to exchange data, in particular in the form of radiofrequency signals.

Although for clarity reasons, FIG. 1 shows only one server 2 and one communicating lock 3, the system for monitoring goods according to the invention may comprise several servers and a plurality of communicating locks 3. Likewise, the server 2 may be replaced by a computer, a smart phone or any other type of computer terminal.

Alternatively, the server 2 is in turn connected to another computer terminal through a computer network, whether a local network (LAN) or global network (WAN), via a communication link that may be wired or wireless.

As shown schematically in FIG. 1, the communicating lock 3 is preferably intended to be affixed on a container, which appears schematically in the figure to the left of the communicating lock 3, for example against the gates thereof. To that end, the communicating lock 3 is provided with fastening means, for example in the form of screws, links or magnets. As will be described below, the communicating lock 3 is advantageously provided with means that allow the goods transported in the container to be secured.

The system for monitoring goods according to the invention further comprises at least one measuring sensor 4 intended to be affixed in contact with the goods, whether directly on the goods or any other form of packaging or support generally used to transport goods (cartons, pallets, boxes, etc.). As described below, the measuring sensor 4 comprises communication means making it capable of two-way communication with the communicating lock 3, preferably in the form of radiofrequency signals.

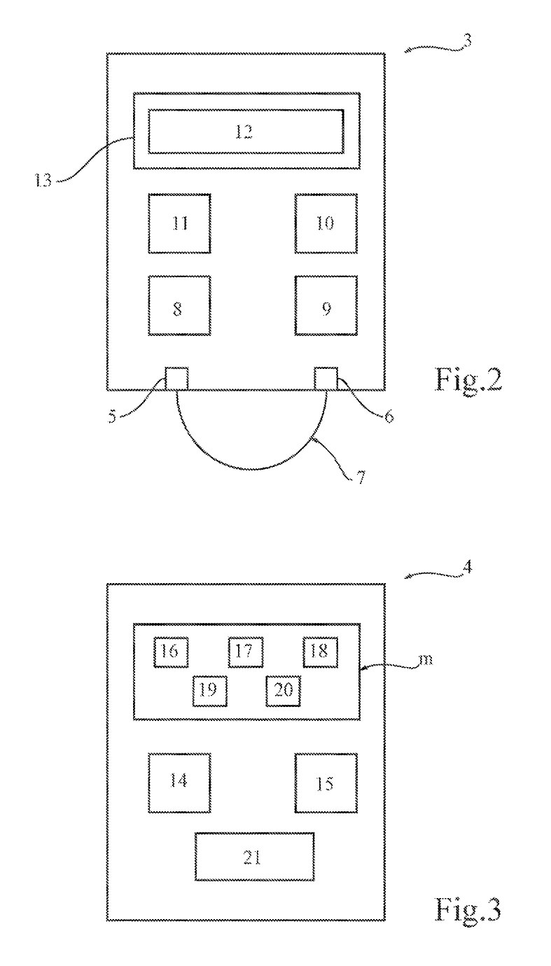

FIG. 2 shows the components that make up a communicating lock 3 of a system for monitoring goods according to the invention.

The communicating lock 3 comprises inspection means 8, including at least a processor and memory, and communication means 9 for communicating with the server 2, via the communication channel C, and with the measuring sensor 4. The inspection means 8 are connected to the communication means 9, such that the inspection means 8 are able to command the communication means 9 to trigger the sending of signals, preferably radiofrequency signals, by the communication means 9.

The communication means 9 are two-way means, i.e., they are able to send and receive signals, preferably radiofrequency signals. They may further be configured and adapted to use near field communication (NFC) protocols. The communication means 9 are able to transfer received signals to the inspection means 8 so that the inspection means 8 analyze the received signals and, if necessary, perform actions.

The control means 8 are configured to determine whether the measuring parameters set by the measuring sensor 4 comply with a predefined setpoint parameter.

To that end, at least one setpoint parameter and/or at least one allowance parameter are recorded in the memory of the control means 8 opposite one or more physical parameters measured by the measuring sensor 4.

As a function of the received measuring parameters, the inspection means 8 command the communication means 9 to trigger the sending of alarm signals intended for the central server 2. The inspection means 8 can trigger the sending of alarm signals with respect to any measured physical parameter.

Alternatively, according to the characteristics of the measuring sensor 4 as described below, the inspection means 8 command the communication means 9 to trigger the sending of alarm signal intended for the server 2 after receiving an alarm signal sent by the measuring sensor 4.

Advantageously, the measurement of the light intensity by the measuring means of the sensor 4, as described below, allows the quick detection, practically in real-time, of an attempt to access the goods. Indeed, when the goods are accessed, the light environment is altered, for example when opening a tarp of a trailer or a door of a container.

The communicating lock further comprises a geolocation module 10, for example a GPS receiver, that is connected to the inspection means 8 such that the inspection means 8 are able to interact with the geolocation module 10 to determine the location of the lock on the planet. For location purposes of the communicating lock 3, the inspection means 8 are configured to command the communication means 9 to send regular location signals containing location data to the server 2.

The communicating lock 3 further comprises means for detecting movement 11, for example an accelerometer, that are connected to the control means 8 such that the control means 8 are able to interact with the movement detection module 11 to determine any movement of the communicating lock 3. For securing and monitoring purposes, the inspection means 8 are configured to command the communication means 9 to send signals regularly containing data reporting the detected movements at the communicating lock 3 intended for the server 2.

Lastly, the communicating lock 3 comprises power supply means 12, for example a lithium battery, which are preferably dimensioned to impart operating autonomy exceeding sixty days to the communicating lock 3, taking account of an activation of the communication means 9, whether to send and/or receive radiofrequency signals, at least every fifteen minutes. The power supply means 12 are also confined in a box 13 made from a material chosen to limit the propagation of a fire resulting from a failure of the power supply means to the entire communicating lock 3. Preferably, this material is aluminum or a mixture of polycarbonate and acrylonitrile butadiene styrene.

Optionally, the communicating lock 3 comprises a first jack 5 and a second jack 6, to each of which one end of an optical fiber 7 can be connected. Preferably, the first jack 5 is able to generate a light flow. Alternatively or additionally, the second jack 6 is able to generate a light flow.

In this case, the inspection means 8 are also configured so as, when both ends of an optical fiber are connected in the jacks 5 and 6, to determine the integrity of the connected optical fiber. By detecting whether the light flow intended to travel between the jacks 5, 6 is present or by measuring the intensity variations thereof, the inspection means 8 are able to establish whether the connected optical fiber has been damaged. Alternatively or additionally, the inspection means 8 are configured to detect the status of each of the jacks 5 and 6. In other words, the inspection means 8 are configured to determine whether each of the jacks 5 and 6 is connected or disconnected, i.e., whether the end of an optical fiber is or is not connected in the jack.

If the ends of an optical fiber are connected to the jacks 5 and 6 and the inspection means 8 detect a break of the light flow between the jacks 5 and 6, the inspection means 8 are configured to command the sending of a radiofrequency signal by the communication means 9, for example assuming the form of an alarm signal. Likewise, if the inspection means 8 detect a change in status of one of the jacks 5, 6, for example a passage from the connected status to the disconnected status, the inspection means 8 are able to command the communication means 9 to send a radiofrequency signal.

Thus, in light of the fragility of an optical fiber, it becomes difficult to open the doors of a container on which the communicating lock 3 is affixed provided with an optical fiber positioned carefully without disconnecting or breaking the optical fiber and therefore without influencing the intensity of the light flow circulating between the jacks 5 and 6. It is also difficult to produce a bridging on an optical fiber. Yet since the inspection means 8 are configured to command the sending of a radiofrequency signal, preferably intended for the server 2, if a break in the light flow is detected, whether due to damage of the fiber or the status change of one of the jacks, the server 2 is informed practically in real-time when such an event occurs.

Consequently, the communicating lock 3, especially when it is affixed on the door of a container, increases the security of goods against thefts while being able to detect, in various manners, an intrusion within the container, either by analyzing the physical parameters measured by the measuring sensor, for example a measurement of the light intensity, or by using electromechanical means, resting on movement detection means, or optionally, on the use of an optical fiber.

For these reasons, in particular in light of the characteristics of the communicating lock 3, the system for monitoring goods according to the invention improves the speed with which an intrusion can be detected seeking to access transported goods, or, throughout entire the transport journey, an alteration of the transport conditions. As a result, the monitoring system for goods according to the invention indirectly improves protection of the goods from theft and alteration.

FIG. 3 shows the components that make up a measuring sensor 4 of a system for monitoring goods according to the invention.

The measuring sensor 4 comprises measuring means m, a processor 14, communication means 15, able to provide two-way communication with the communication means 9 of the communicating lock 3, a memory 21 and power supply means, in the form of a fuel cell or battery (not shown).

The measuring means m comprise means for measuring the ambient temperature 16, in other words one or several thermometers, means for measuring the ambient humidity 17, in other words one or several hygrometers, means for measuring the light intensity 18, for example including one or several photodiodes, and means for measuring the pressure 19. Alternatively or additionally, the measuring means m comprise means for detecting the presence of a gas, for example for measuring the ambient levels of carbon monoxide or another type of gas. The measuring means m perform regular measurements of the physical parameters set out above upon command by the processor 14.

The processor 14 is configured to interact with the measuring means m in order to command regular taking of measurements, by the measuring means m, of the physical parameters set out below. Preferably, the processor interacts with the memory 21 to extract a frequency parameter therefrom that is recorded therein in order to determine the moments at which to command the taking of measurements by the measuring means m.

Furthermore, the processor 14 is configured to command the communication means 15 such that the measurements done via the measuring means m are sent by the measuring sensor 4 to the communicating lock 3, which, as of receipt, resends the measurements to the server 2.

Furthermore, the processor 14 is configured to interact with the memory 21 such that it commands the recording of the measurements via the measuring means m in the memory 21. To that end, the memory 21 is capable of sustainably storing several measuring parameters relative to the measurements of physical parameters done by the measuring means m.

Thus, in the case where the measuring sensor 4 cannot communicate with the communicating lock 3, for example in the case where the communication channel between the communication means 15 of the measuring sensor 4 and the communication means 9 of the communicating lock 3 is not available, the processor 14 is configured to command the recording of the measured physical parameters in the memory 21. Next, either the measured physical parameters can be sent to the communicating lock 3 when the communication channel is available again, or the parameters can be read directly in the memory 21 using a reader, preferably connected by a communication channel to the server 2, while interacting with the communication means 15 of the measuring sensor 4, for example using a near field communication (NFC) protocol. Preferably, the processor 14 is able to determine the availability of the communication channel with the communicating lock 3. In the case where the processor 14 detects that the communication channel is unavailable, it automatically commands the recording of the measurements in the memory 21. Alternatively, if the communication channel between the measuring sensor 4 and the communicating lock 3 is available, the processor commands the recording of the measurements in the memory 21.

Optionally, the processor 14 is configured to determine whether a measured parameter exceeds a predefined threshold or deviates significantly from a setpoint parameter. In this case, a modifiable setpoint parameter and/or an allowance parameter are recorded in the memory 21 opposite at least one physical parameter measured by the sensor. In this case, the processor 14 is also configured to command the sending of signals by the communication means 15, for example when the value of the measurement of a physical parameter deviates significantly from a setpoint value.

The communication means 15 are able to send and receive radiofrequency signals, in particular to interact with the communication means 9 of the communicating lock 3. When the communication can be established, the measuring sensor 4 sends, via the communication means 15, the measured parameters to the communicating lock 3 at time intervals determined as a function of the frequency parameter stored in the memory 21. The communicating lock resends the received data to the server 2. The server 4 is therefore informed regularly and/or in real-time of the transport conditions of the goods. Consequently, the system for monitoring goods according to the invention is continuously able to provide information regarding the transport conditions of the goods.

Additionally, even if the communication between the measuring sensor 4 and the communicating lock 3 is impossible, the measured physical parameters are not lost, but available in the memory 21 where they are recorded.

These characteristics contribute to allowing the system for monitoring goods according to the invention to be able to determine the transport conditions not only at different predetermined points of the transport journey, but throughout the entire transport chain. Furthermore, even in the case where, during the journey, the measuring sensor 4 has not been able to send some of the measured physical parameters, it remains possible to determine the transport conditions throughout the entire journey. In the context of the transport of perishable foodstuffs, the characteristics of the measuring sensor 4 are particularly advantageous.

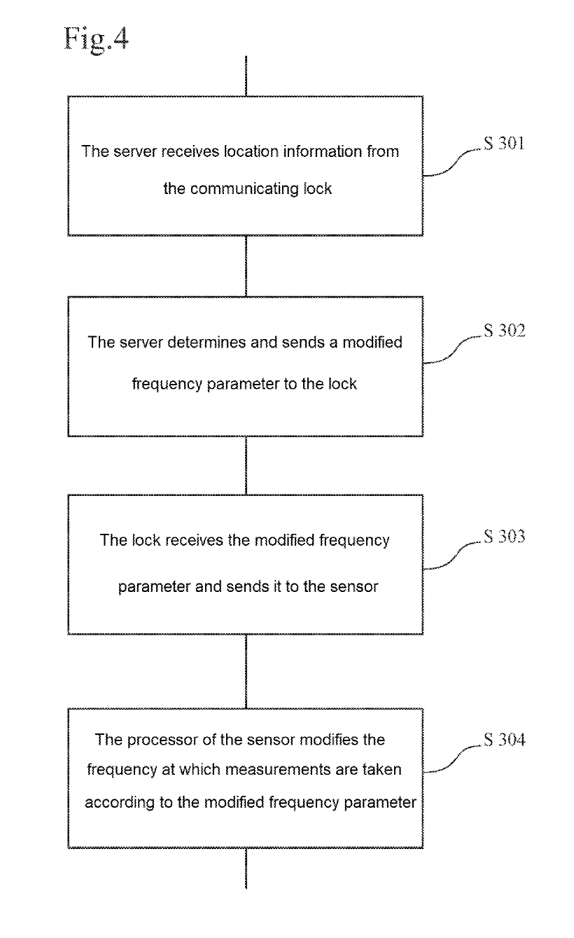

FIG. 4 illustrates another aspect of the invention, which relates to a monitoring method implemented with the system for monitoring goods according to the invention.

As described above, the system for monitoring goods according to the invention operates primarily according to a normal operation mode in which the measuring sensor 4 regularly measures physical parameters according to a frequency parameter stored in the memory 21. However, the system for monitoring goods according to the invention is also able to operate according to a specific operating mode during the implementation of a monitoring method that is articulated as described below.

The monitoring method according to the invention comprises a first step S301 during which the server 2 receives location information sent by the communicating lock 3, the location information providing a certain position of the communicating lock 3 on the planet. In a second step S302, the server 2 determines and sends a modified frequency parameter to the communicating lock 3. In a third step S303, the communicating lock 3 receives and sends the modified frequency parameter to the measuring sensor 4. Upon receipt of the modified frequency measurement by the communication means 15 of the measuring sensor 4, the processor 14 commands the storing of the modified frequency parameter in the memory 21. Next, the processor 14 controls the measuring means m so that the measurement of the physical parameters is done at determined time intervals as a function of the modified frequency parameter.

By carrying out the monitoring method as described above, the system for monitoring goods according to the invention is able to verify the frequency at which the transport conditions are inspected, as a function of where the goods are located. Thus, the transport conditions can be inspected more thoroughly in some locations on the transport journey and less so in other places. Thus, the monitoring method according to the invention for example makes it possible to account for the dangerousness of certain places on the transport journey and to modify the manner in which the transport conditions are monitored accordingly.

According to one alternative embodiment, the method comprises a fourth step S304 during which the server 2 receives new location information from the communicating lock 3. In a fifth step S305, the server 2 sends stop information to the communicating lock 3, which, in a sixth step S306, sends the stop information to the measuring sensor 4. In a seventh step S307, the processor 14 analyzes the stop information and, as a function thereof, commands the immediate or later extinguishing of the measuring means m.

The steps of the monitoring method according to the invention give the system for monitoring goods according to the invention the ability to remotely control the deactivation of the measuring sensor 4 as a function of the location of the goods on the planet. It is thus possible not to consume the battery of the measuring sensor when it is not necessary, for example when the goods are reaching their destination or stored in an environment where the environmental conditions (temperature, pressure, humidity, etc.) are known, such that it becomes pointless to observe them.

1. A system for monitoring goods comprising at least one server, characterized in that the system comprises
at least one communicating lock at least one measuring sensor, the communicating lock comprising inspection means and first communication means,
the first communication means being configured to send and receive radiofrequency signals,
the measuring sensor comprising a processor measuring means (m) for measuring at least one physical parameter, a memory and second communication means,
the memory being able, upon instructions from the processor, to lastingly store at least one value of a physical parameter measured using the measuring means (m),
the second communication means being configured to send radiofrequency signals,
the inspection means and/or the processor being configured to determine whether a value of a physical parameter measured using the measuring means (m) is compliant with a setpoint parameter.

2. The system according to claim 1, characterized in that the communicating lock comprises
a first and second jack for connecting the two ends of an optical fiber, the inspection means being able, when the first end of the fiber is connected to the first jack and the second end of the fiber is connected to the second jack, to determine the integrity of an optical fiber and the connected or disconnected status of the first and second jacks.

3. The system according to claim 1, characterized in that the second communication means are configured to receive radiofrequency signals.

4. The system according to claim 1, characterized in that the measuring means (m) can comprise means for measuring the ambient temperature.

5. The system according to claim 1, characterized in that the measuring means comprise means for measuring the ambient humidity.

6. The system according to claim 1, characterized in that the measuring means comprise means for measuring the light intensity.

7. The system according to claim 1, characterized in that the measuring means comprise means for measuring the pressure.

8. The system according to claim 1, characterized in that the measuring means comprise means for detecting the presence of a gas.

9. The system according to claim 1, characterized in that the communicating lock comprises a geolocation module.

10. The system according to claim 1, characterized in that the communicating lock comprises a movement detection module.

11. The system according to claim 1, characterized in that the communicating lock comprises power supply means confined in a box made from a material limiting the propagation risks of a fire resulting from a failure of the power supply means to the entire communicating lock.

12. The system according to claim 11, characterized in that the material is aluminum or a mixture of polycarbonate and acrylonitrile butadiene styrene.

13. A method for monitoring goods implemented by a system for monitoring goods according to claim 1, characterized in that the method comprises the following steps:
reception by the server a first piece of location information sent by the communicating lock;
sending by the server of a work instruction intended for the communicating lock the work instruction indicating a measurement frequency;
sending by the communicating lock of the work instruction to the measuring sensor (4); and
modification by the processor of the measuring sensor of the frequency of the measurements done using the measuring means (m) of the measuring sensor based on the work indication.

14. The monitoring method according to claim 13, characterized in that it comprises the following steps:
reception by the server of a second piece of location information sent by the communicating lock;
sending by the server of a stop instruction intended for the communicating lock;
sending by the communicating lock of the stop instruction intended for the measuring sensor; and
extinguishing of the measuring means (m) of the measuring sensor.
